(19) United States
(12) Patent Application Publication
(10) Pub. No.: US 2019/0183061 A1
(43) Pub. Date: Jun. 20, 2019

(54) Smart Basket

(71) Applicant: Dongguan Zheng Rong Digital Audio Co., Ltd., Dongguan City (CN)

(72) Inventor: Chao-Rong Huang, Dongguan City (CN)

(73) Assignee: Dongguan Zheng Rong Digital Audio Co., Ltd.

(21) Appl. No.: 15/842,399

(22) Filed: Dec. 14, 2017

(51) Int. Cl. A01G 9/02; A01G 27/02; A01G 7/04

(52) U.S. Cl. CPC A01G 9/02; A01G 7/045; A01G 27/02

(57) ABSTRACT

A smart basket includes a basket body and a handle. The handle is located above the basket body. A plant light is connected with a manual switch through a conducting wire. The plant light is further connected with an interior of the basket body through the conducting wire. An inner side of the basket body is provided with a water hopper, a plastic inner tray, and an atomizer. An upper surface of the plastic inner tray is provided with collection grooves. The upper surface of the plastic inner tray is fixedly connected with the water hopper. The LED plant light of the smart basket provides the plant in the basket three-dimensional supplemental light, such that the plant can absorb light energy more evenly. The amount of the water in the water storage tank can be monitored, and the data can be transmitted to the user via Bluetooth.

### FIELD OF THE INVENTION

The present invention relates to a smart basket, and more particularly to a smart basket able to provide plants three-dimensional supplemental light and automatically supply water and nutrients in an intelligent manner.

### BACKGROUND OF THE INVENTION

A flower basket is a basket used for placement of flowers or serving as a container for a flower arrangement. It is one of the most commonly used forms of floral decorations for social and ceremonial occasions, such as opening ceremony, celebrating, welcoming, meeting, birthday, wedding and funeral occasions. Some consumers purchase flower baskets for growing beautiful flowers. However, the indoor light is insufficient for the flowers, so the flowers cannot get enough water and nutrients. Using tap water not only causes a water waste but also affects the growth of plants.

### SUMMARY OF THE INVENTION

The primary object of the present invention is to provide a smart basket able to provide plants three-dimensional supplemental light and automatically supply water and nutrients in an intelligent manner so as to solve the problems of the prior art.

In order to achieve the above-mentioned object, the smart basket of the present invention comprises a basket body and a handle. The handle is located above the basket body. Two ends of the handle are fixedly connected to the basket body. An outer side of the handle is provided with a plant light and a manual switch. The plant light is connected with the manual switch through a conducting wire. The plant light is further connected with an interior of the basket body through the conducting wire. An inner side of the basket body is provided with a water hopper, a plastic inner tray, and an atomizer. A bottom edge of the plastic inner tray is connected to the basket body. An inner side of the plastic inner tray is provided with a water storage tank. An upper surface of the plastic inner tray is provided with collection grooves. The collection grooves are evenly arranged on the upper surface of the plastic inner tray. The upper surface of the plastic inner tray is fixedly connected with the water hopper. A side wall of the water hopper is fixedly connected with an inner wall of the plastic inner tray. A bottom of the water hopper is provided with at least one water injection hole. One side of the water hopper is provided with the atomizer. An outer side of the atomizer is fixedly connected with the plastic inner tray. A bottom end of the atomizer is inserted into an interior of the water storage tank. The interior of the water storage tank is stored with water and nutrients. A water level sensor and a Bluetooth module are mounted on an inner side wall of the water storage tank. The water level sensor is electrically connected with the Bluetooth module.

Preferably, the water injection hole is located over the water storage tank.

Preferably, the manual switch is mounted at the junction of the handle and the basket body.

Preferably, the plant light adopts an LED light source.

Preferably, the collection grooves are radially disposed and located under the atomizer.

Compared to the prior art, the present invention has the beneficial effects described below. The LED plant light of the smart basket of the present invention provides the plant in the basket three-dimensional supplemental light, such that the plant can absorb light energy more evenly, meanwhile, the big data in the background can adjust the length of time of the supplemental light according to different plants. The atomizer supplies water to the root of the plant precisely according to the need of the plant's different growth cycle based on the big data. The water level sensor inside the water storage tank cooperates with the Bluetooth module to monitor the amount of the water in the water storage tank, and the data can be transmitted to the user via Bluetooth to improve the user's feeling.

### BRIEF DESCRIPTION OF THE DRAWINGS

FIG. 1 is a perspective view of the present invention;

FIG. 2 is a side view of the present invention;

FIG. 3 is a top view of the present invention; and

FIG. 4 is a sectional view of the plastic inner tray of the present invention.

### DESCRIPTION OF THE PREFERRED EMBODIMENTS

Advantages and features of the inventive concept and methods of accomplishing the same may be understood more readily by reference to the following detailed description of embodiments and the accompanying drawings. The inventive concept may, however, be embodied in many different forms and should not be construed as being limited to the embodiments set forth herein. It will be understood by those of ordinary skill in the art that various changes in form and details may be made therein without departing from the spirit and scope of the present invention as defined by the following claims and their equivalents.

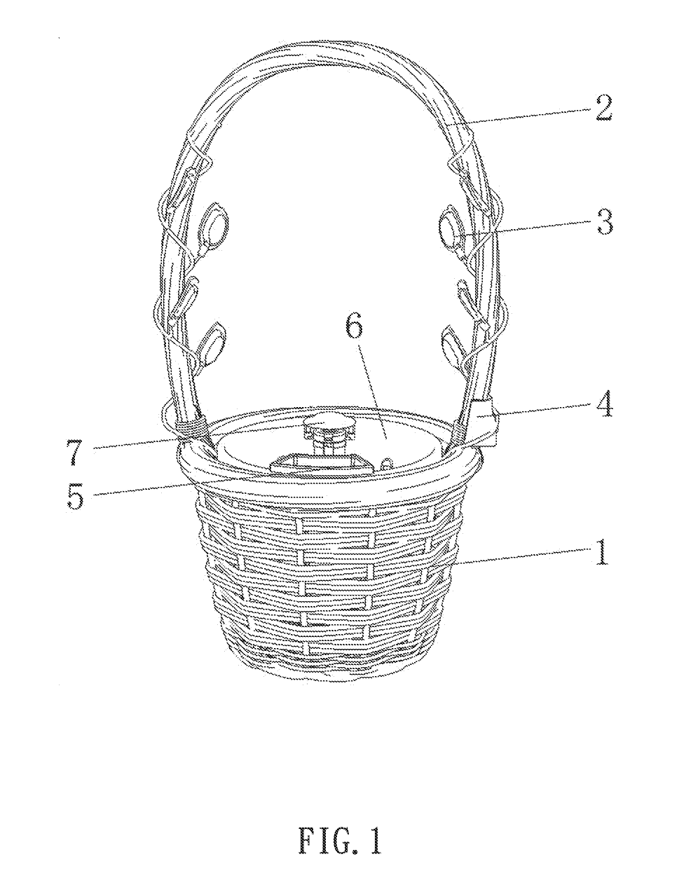

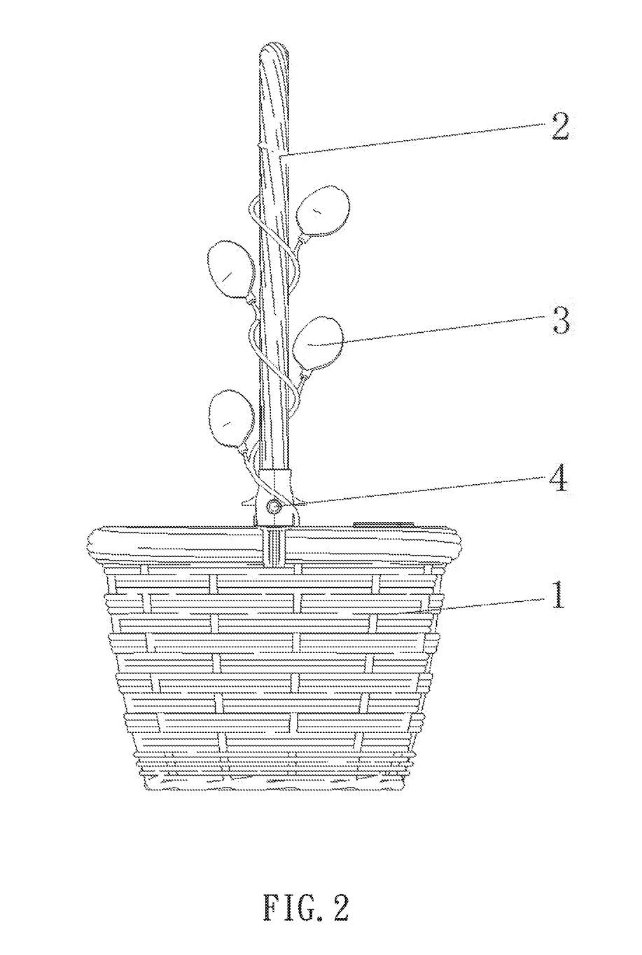

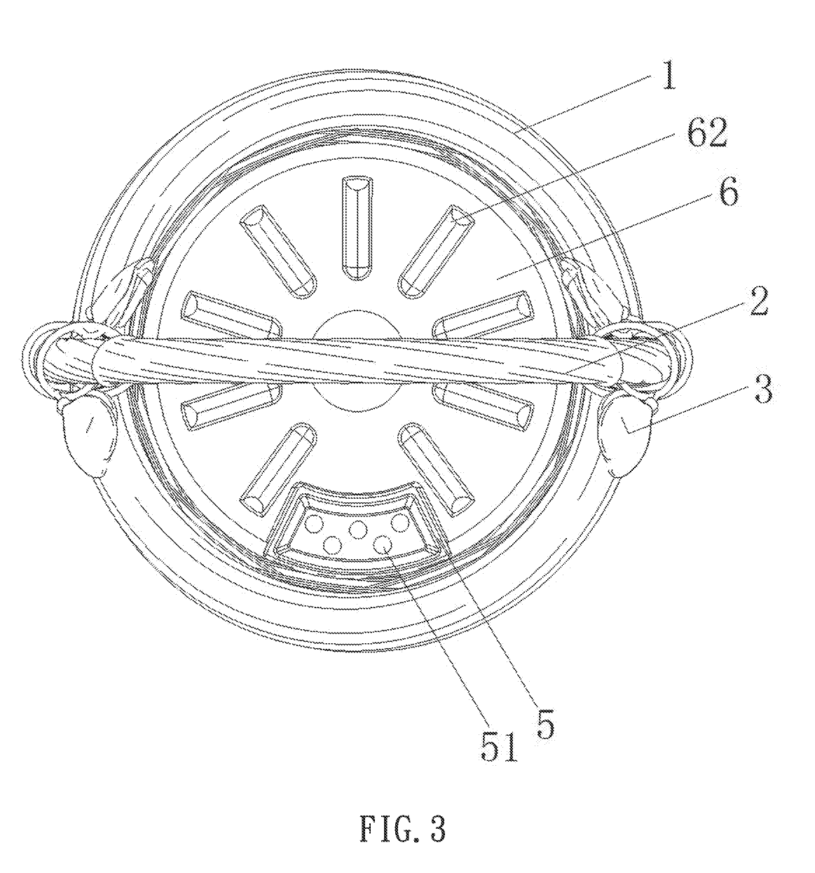

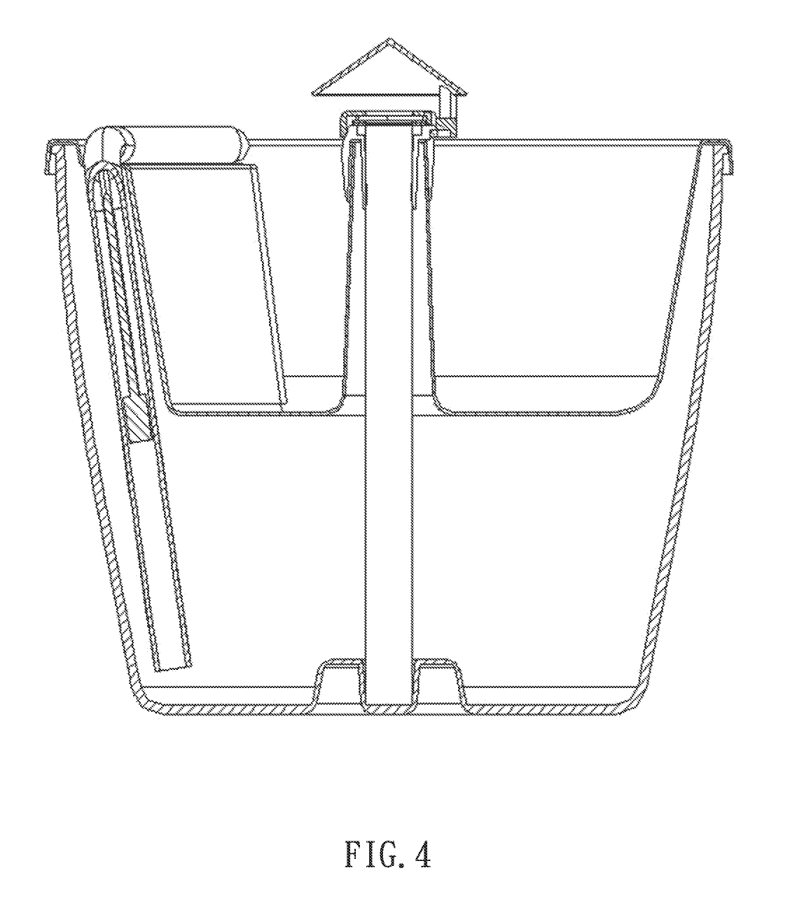

Referring to FIG. 1 to FIG. 4, a smart basket in accordance with an embodiment of the present invention comprises a basket body 1 and a handle 2. The handle 2 is located above the basket body 1. Two ends of the handle 2 are fixedly connected to the basket body 1. An outer side of the handle 2 is provided with a plant light 3 and a manual switch 4. The manual switch 4 is mounted at the junction of the handle 2 and the basket body 1. The manual switch 4 is adapted to manually control the power source of the smart basket to be turned on/off. The plant light 3 is connected with the manual switch 4 through a conducting wire. The plant light 3 adopts an LED light source. The plant light 3 in the form of an LED light source is configured to provide the plant in the basket three-dimensional supplemental light, such that the plant can absorb light energy more evenly. The big data in the background can adjust the length of time of the supplemental light according to different plants. The plant light 3 is further connected with the interior of the basket body 1 through the conducting wire. An inner side of the basket body 1 is provided with a water hopper 5, a plastic inner tray 6, and an atomizer 7. A bottom edge of the plastic inner tray 6 is connected to the basket body 1. An inner side of the plastic inner tray 6 is provided with a water storage tank 61. The water storage tank 61 is filled with water and nutrients. An upper surface of the plastic inner tray 6 is provided with collection grooves 62. The collection grooves 62 are radially disposed and located under the atomizer 7. The atomizer 7 supplies water to the root of the plant precisely according to the need of the plant's different growth cycle based on the big data. The collection grooves 62 are evenly arranged on the upper surface of the plastic inner tray 6. The upper surface of the plastic inner tray 6 is fixedly connected with the water hopper 5. The water hopper 5 is used for injecting water. A side wall of the water hopper 5 is fixedly connected with an inner wall of the plastic inner tray 6. A bottom of the water hopper 5 is provided with at least one water injection hole 51. The water injection hole 51 is located over the water storage tank 61. The water from the water injection hole 51 will be stored in the water storage tank 61. One side of the water hopper 5 is provided with the atomizer 7. The atomizer 7 delivers the required nutrient solution to the plant from the bottom to the top by means of atomization so as to meet the requirements for water absorption and nutrition of the plant. An outer side of the atomizer 7 is fixedly connected with the plastic inner tray 6. A bottom end of the atomizer 7 is inserted into the interior of the water storage tank 61. The interior of the water storage tank 61 is stored with water and nutrients. A water level sensor 63 and a Bluetooth module 64 are mounted on an inner side wall of the water storage tank 61. The water level sensor 63 is electrically connected with the Bluetooth module 64. The water level sensor 63 cooperates with the Bluetooth module 64 to monitor the amount of the water in the water storage tank 61, and the data can be transmitted to the user via Bluetooth.

In summary, the LED plant light 3 of the smart basket of the present invention provides the plant three-dimensional supplemental light, such that the plant can absorb light energy more evenly, meanwhile, the big data in the background can adjust the length of time of the supplemental light according to different plants. The atomizer 7 supplies the water and nutrient solution to the root of the plant. The water level sensor 63 inside the water storage tank 61 cooperates with the Bluetooth module 64 to monitor the amount of the water in the water storage tank 61, and the data can be transmitted to the user via Bluetooth to improve the user's feeling.

From the foregoing, it will be noted that various embodiments of the disclosed subject matter have been described herein for purposes of illustration, and that various modifications may be made without departing from the scope and spirit of the subject disclosure. Accordingly, the various embodiments disclosed herein are not intended to be limiting, with the true scope and spirit being indicated by the appended claims.

It should be understood that the exemplary embodiments described therein should be considered in a descriptive sense only and not for purposes of limitation. Descriptions of features or aspects within each embodiment should typically be considered as available for other similar features or aspects in other embodiments. It should be noted that those ordinarily skilled in the art know that all possible combinations of examples cannot be explained, and also know that various combinations can be derived from the technique of the present specification. Therefore, the protection scope of the invention should be determined by combining various examples described in the detailed explanation, without departing from the scope of the following claims.

What is claimed is:

1. A smart basket, comprising a basket body and a handle, the handle being located above the basket body, two ends of the handle being fixedly connected to the basket body, an outer side of the handle being provided with a plant light and a manual switch, the plant light being connected with the manual switch through a conducting wire, the plant light being further connected with an interior of the basket body through the conducting wire, an inner side of the basket body being provided with a water hopper, a plastic inner tray, and an atomizer, a bottom edge of the plastic inner tray being connected to the basket body, an inner side of the plastic inner tray being provided with a water storage tank, an upper surface of the plastic inner tray being provided with collection grooves, the collection grooves being evenly arranged on the upper surface of the plastic inner tray, the upper surface of the plastic inner tray being fixedly connected with the water hopper, a side wall of the water hopper being fixedly connected with an inner wall of the plastic inner tray, a bottom of the water hopper being provided with at least one water injection hole, one side of the water hopper being provided with the atomizer, an outer side of the atomizer being fixedly connected with the plastic inner tray, a bottom end of the atomizer being inserted into an interior of the water storage tank, the interior of the water storage tank being stored with water and nutrients, a water level sensor and a Bluetooth module being mounted on an inner side wall of the water storage tank, the water level sensor being electrically connected with the Bluetooth module.

2. The smart basket as claimed in claim 1, wherein the water injection hole is located over the water storage tank.

3. The smart basket as claimed in claim 1, wherein the manual switch is mounted at the junction of the handle and the basket body.

4. The smart basket as claimed in claim 1, wherein the plant light adopts an LED light source.

5. The smart basket as claimed in claim 1, wherein the collection grooves are radially disposed and located under the atomizer.
